(19) United States
(12) Patent Application Publication
(10) Pub. No.: US 2019/0202579 A1
(43) Pub. Date: Jul. 4, 2019

(54) IMPROVEMENTS TO AIRCRAFT TAXIING

(71) Applicant: Steven Dennis John Costello, London Greater London (GB)

(72) Inventor: Steven Dennis John Costello, London Greater London (GB)

(21) Appl. No.: 16/314,075

(22) PCT Filed: Jun. 30, 2017
(86) PCT No.: PCT/GB2017/051939

§ 371 Date: Dec. 28, 2018

(30) Foreign Application Priority Data
Jun. 30, 2016 (GB) 1611485.2

(51) Int. Cl. B64F 1/22; G05D 1/00; B64F 1/36; B60L 53/12

(52) U.S. Cl. CPC B64F 1/228; G05D 1/0011; B60L 53/32; B60L 53/12; G05D 2201/02; B64F 1/36

(57) ABSTRACT

The invention relates to a system for inductively powering all aircraft tug, the system comprising: an inductive powering strip adapted to be provided in association with a taxiway; said inductive powering strip defining a path for an aircraft tug. The invention also relates to an aircraft tug comprising means to be inductively powered and a method for inductively powering an aircraft tug.

### FIELD

The present invention relates to improvements to aircraft taxiing. More particularly, the present invention relates to an improved vehicle, system, and runway layout used in relation to aircraft taxiing.

### BACKGROUND

In a conventional airport arrangement, aircraft are parked on stands (also referred to as bays), or in hangars before they are required for use. The aircraft then use the power of their integrated jet or propeller engines to propel themselves via aprons and taxiways onto the runway itself. The integrated aircraft propulsion systems are designed for optimum efficiency in the air and are very inefficient when propelling the aircraft along the ground, which represents an inefficient use of fuel, as well as contributing to noise pollution, engine wear, CO₂, and particulate emissions. Aircraft ground movements account for c.30% of Heathrow airport's carbon emissions and any improvements therefore assist in meeting legally binding air quality targets.

An improved solution is therefore desired.

### SUMMARY OF INVENTION

The present invention seeks to provide a more efficient method, apparatus and system for aircraft transport when moving on the ground. The present invention relates to an inductively powered aircraft taxi vehicle, an associated system and methods of operation.

In one aspect of the present invention, an aircraft tug comprising means to be inductively powered is provided. Such a tug may be suitable for towing aircraft, for example commercial aircraft such as twin, or four-engine aircraft. In particular, the tug may be adapted to tow commercial passenger-carrying aircraft or freight aircraft. The tug comprises means for coupling with an aircraft, for example a tow bar attachable to a nose-wheel assembly, or a platform on which a nose-wheel assembly can be supported.

According to one aspect of the invention there is provided a system for inductively powering an aircraft tug, the system comprising: an inductive powering strip adapted to be provided in association with a taxiway; said inductive powering strip defining a path for an aircraft tug. In such a way an aircraft may be moved along the ground in a quiet, green and energy efficient manner,

For energy efficiency and/or to improve control, the system may further comprise means for selectively powering a section of said inductive powering strip.

For safety and control, the system may further comprise means for determining the position of an aircraft tug.

Preferably, the means for determining the position of an aircraft tug comprises sensors adapted to be provided in association with said taxiway.

For longevity, the inductive powering strip may be adapted to be embedded within a taxiway.

Preferably, the path for an aircraft tug follows an aircraft taxi path.

So as to reduce the weight of the aircraft damaging the powering strip, the inductive powering strip may be offset from an aircraft nose-wheel line.

For redundancy, the system may further comprise a second inductive powering strip offset from said inductive powering strip.

Preferably, the inductive powering strip and said second powering strip are disposed either side of an aircraft nose-wheel line.

So as to reduce the weight of the aircraft damaging the powering strip(s), the inductive powering strip and/or said second powering strip is offset from the aircraft nose-wheel line by between 0.1 and 3 m; preferably between 0.2 m and 2 m; and more preferably between 0.5 m and 1 m.

Preferably, the path comprises markings on said taxiway adapted to be detected and followed by an aircraft tug, preferably wherein said markings comprise a line.

For providing access to a runway, the path comprises a path to an area in which aircraft access a runway.

For providing access from a runway (for example to a terminal), said path comprises a path from an area in which aircraft depart from a runway.

For operational efficiency, the system may further comprise a subterranean path for an aircraft tug. Preferably, the subterranean is between 1 m-4 m in height, preferably between 2 m-3 m in height; preferably the subterranean path is between 2 m-12 m in width.

For operational efficiency, the subterranean path is provided at a location so as to circumvent an obstacle.

For operational efficiency, the subterranean path is provided at a location to circumvent an area in which aircraft move; an area in which other tugs move; or airport infrastructure.

For operational efficiency, the subterranean path is from an end of the taxi path at an area in which an aircraft accesses a runway.

For operational efficiency, the system may further comprise means for aircraft tugs to pass one another. Preferably, the means for aircraft tugs to pass one another comprise at least one sidings or a passing loop.

The system may further comprise means for controlling an aircraft tug operating within the system.

For safety, the controlling means may comprise a controller in a cockpit of an aircraft.

For central control, the controlling means may comprise a central controller.

For efficiency and/or flexibility of use, the system may be adapted to switch between two control means in dependence on whether the tug is coupled to an aircraft.

Preferably, the controlling means is adapted to wirelessly control one or more aircraft tugs using said system.

For melting ice or snow, the system may further comprise a heating element following the same path as said inductive powering strip.

For energy efficiency, the heating element may be adapted to utilise heat generated from said inductive powering strip.

Preferably the system is incorporated into an airport taxiway arrangement, preferably into a runway arrangement, preferably into an airport.

Preferably the system further comprises an aircraft tug vehicle.

According to another aspect of the present invention there is provided an aircraft tug comprising means to be inductively powered. An inductively powered aircraft tug may provide energy efficiency and safety improvements. The means to be inductively powered may comprise a pick-up coil and an electric motor.

For efficiency, the aircraft tug may be driverless.

So as to remain on a predefined path, the aircraft tug may comprise means for following a predefined path. The means for following a predefined path may comprise means for determining a peak inductance. In such a way, no additional sensors are required to determine the path.

For redundancy and/or improved detection, the means for following a predefined path comprises a computer vision system adapted to detect markings on a taxiway. The markings may comprise a line on said taxiway.

Preferably, the aircraft tug further comprises means for steering the aircraft tug to said predefined path.

Preferably, the means to be inductively powered comprises a pick up coil on the underside of the tug.

So that an aircraft wheel does not roll over the inductive strip, the pickup coil may be offset from the centre of the vehicle. The pickup coil may be offset from the centre of the vehicle by between 0.1 and 3 m; preferably between 0.2 m and 2 m; and more preferably between 0.5 m and 1 m.

For redundancy and/or flexibility the tug may further comprise a first and a second means to be inductively powered. The first and a second means to be inductively powered may each comprise a pick up coil on the underside of the tug.

For efficiency, said pick up coil may be less than 50 cm from the ground, preferably less than 20 cm from the ground, preferably, between 10 cm and 30 cm from the ground.

For operational efficiency and/or safety the aircraft tug may further comprise means for determining its location.

Preferably, the means for determining its location comprises means for receiving data.

The means for determining its location may comprise sensors adapted to sense position-determining features on said taxiway. Fixed locations around the taxiway may be sensed and the position of the tug determined.

For central control, the aircraft tug according may comprise a receiver module adapted to receive instructions from a controller.

For enabling a different operating mode, the aircraft tug may further comprise means for determining that the tug is coupled to an aircraft.

Preferably, the aircraft tug comprises means for switching control of the tug in dependence on whether it is coupled to an aircraft; preferably wherein said control is from said aircraft when coupled, and from a central controller when not coupled.

For ease of moving an aircraft and/or avoiding stress on the nose-wheel, the aircraft tug may comprise one or more rollers operable to engage with a nose wheel of an aircraft, wherein the rotation of the one or more rollers is operable to generate a rotation of the nose wheel of said aircraft.

For efficiency of coupling, the longitudinal axis of the one or more rollers is substantially parallel to the axis of rotation of the nose wheel of said aircraft.

So as to not require additional elements, the rotation of the one or more rollers is sufficient to bodily move an aircraft.

For mechanical advantage, the longitudinal axis of the one or more rollers is positioned closer to the rear than the front of the aircraft tug.

So as to allow the nose wheel of the aircraft to be offset from the route of the aircraft tug, the one or more rollers may protrude from the aircraft tug. Preferably, the one or more rollers protrudes more from one side of the aircraft tug than the other.

For redundancy and/or ease of reversing direction of travel, the aircraft tug may comprise two rollers.

For ease of reversing direction, the two rollers protrude from opposing sides of the aircraft tug.

According to another aspect of the invention there is provided an aircraft tug for use in the system as described herein.

According to another aspect of the invention there is provided a method of inductively powering an aircraft tug, the method comprising the steps of: powering an inductive powering strip provided in a taxiway; said strip defining a path for an aircraft tug. In such a way an aircraft may be moved along the ground in a quiet, green and energy efficient manner.

For safety and/or operational efficiency, the method may further comprise the step of controlling one or more aircraft tugs. The controlling may comprise transmitting a control signal wirelessly to said one or more aircraft tugs.

For energy efficiency and/or for control, the strip provided in the taxiway may be selectively powered. For example, the inductive powering strip provided in the taxiway may be selectively powered in dependence on the location of an aircraft tug.

Preferably, the method further comprises the step of determining the location of one or more aircraft tugs.

Preferably the method is for use in an airport taxiway arrangement, preferably for use in a runway arrangement, preferably for use in an airport.

According to another aspect of the invention there is provided an aircraft taxiway arrangement comprising a subterranean path for an aircraft tug.

According to another aspect of the invention there is provided an aircraft taxiway arrangement comprising: an area adjoining a runway comprising a plurality spaces for aircraft to queue; each space comprising a path between said runway and a taxiway; wherein each path is independent of one another. In such a manner, aircraft are not dependent on one-another when queuing for a free slot to join or depart from a runway.

Preferably, said taxiway leads to or from a terminal.

For independent operation, the use of one of said plurality of paths does not affect the use of another of said plurality of paths

So as to reduce aircraft tugs interfering with one another or with aircraft. The arrangement may comprise a subterranean path for an aircraft tug.

Preferably, the subterranean path is between 1 m-4 m in height, preferably between 2 m-3 m in height. Preferably, the subterranean path is between 2 m-12 m in width.

According to another aspect of the invention there is provided a sorting of aircraft prior to take-off, the method comprising: providing an area adjoining a runway comprising a plurality spaces for aircraft to queue; arranging a plurality of aircraft in said plurality of bays; instructing the aircraft to take off in order. In such a way efficient operation of the runway arrangement is afforded as aircraft can be sorted at prior to take off at an area adjoining the runway.

The arranging of the plurality of aircraft is by at least one of: aircraft size, runway length required, and wake turbulence produced.

Preferably the arranging of the plurality of aircraft is in the order of the wake turbulence they produce; and said instructing comprises instructing the aircraft to take off in order from the lowest wake turbulence-producing to the most. In such a manner, small aircraft are less affected by wake turbulence.

For efficient use of space, the space provided for the aircraft requiring least runway length is provided at a position further along the runway compared to the space provided for the aircraft requiring most runway length.

For efficiency, and/or noise considerations said aircraft are towed to and/or from said bays. Preferably, the towing is performed using the system as described herein.

According to another aspect of the invention there is provided a system for sorting aircraft prior to take-off, the system comprising: an area adjoining a runway comprising a plurality spaces for aircraft to queue; a plurality of aircraft arranged in said plurality of bays; whereby the aircraft take off in order. In such a way efficient operation of the runway arrangement is afforded as aircraft can be sorted at prior to take off at an area adjoining the runway.

Preferably, the arranging of the plurality of aircraft is by at least one of: aircraft size, runway length required, and wake turbulence produced.

Preferably the arranging of the plurality of aircraft is in the order of the wake turbulence they produce; and said instructing comprises instructing the aircraft to take off in order from the lowest wake turbulence-producing to the most. In such a manner, small aircraft are less affected by wake turbulence.

For efficient use of space, neighbouring spaces for aircraft to wait have different widths according to the size of the aircraft.

According to another aspect of the invention there is provided a method of taxiing aircraft, comprising the steps of: an aircraft tug towing a first aircraft to a runway; the aircraft tug meeting a second aircraft having landed; the aircraft tug towing said second aircraft away from a runway.

For operational efficiency, the aircraft tug may tow the first aircraft to a first end of a runway, and meet the second runway at an opposing end of said runway.

Preferably, the method may further comprise the step of the aircraft tug travelling on an aircraft tug pathway between towing said first aircraft to a runway and meeting said second aircraft.

So as to avoid aircraft tugs interfering with one another or with aircraft, at least a portion of said aircraft tug pathway is subterranean.

For energy efficiency and/or pollution considerations, the aircraft tug may be inductively powered.

The invention extends to any novel aspects or features described and/or illustrated herein.

Further features of the invention are characterised by the other independent and dependent claims.

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

The invention also provides a computer program and a computer program product comprising software code adapted, when executed on a data processing apparatus, to perform any of the methods described herein, including any or all of their component steps.

The invention also provides a computer program and a computer program product comprising software code which, when executed on a data processing apparatus, comprises any of the apparatus features described herein.

The invention also provides a computer program and a computer program product having an operating system which supports a computer program for carrying out any of the methods described herein and/or for embodying any of the apparatus features described herein.

The invention also provides a computer readable medium having stored thereon the computer program as aforesaid.

The invention also provides a signal carrying the computer program as aforesaid, and a method of transmitting such a signal.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

The invention extends to methods and/or apparatus substantially as herein described with reference to the accompanying drawings.

### BRIEF DESCRIPTION OF DRAWINGS

Examples of the present invention will now be described, by way of example only and with reference to the accompanying drawings having like-reference numerals, in which:

FIG. 1a shows an aircraft tug in use;

FIG. 1b shows an alternative aircraft tug in use;

FIG. 1c shows a further alternative aircraft tug in use;

FIG. 1d shows an aerial view of the aircraft tug shown in FIG. 1c;

FIG. 2 shows an aerial view of an example aircraft taxiing system;

FIG. 3 shows a schematic diagram of inductive charging assembly of the electrically powered aircraft tug;

FIG. 4a shows a schematic diagram of an inductive aircraft taxi system;

FIG. 4b shows the inductive aircraft taxi system of FIG. 4a with two inductive strips;

FIG. 5 shows an aerial view of an example departing aircraft staging area;

FIG. 6 shows an aerial view of an example landing aircraft staging area;

FIG. 7 shows example movements of an airport aircraft tug; and

FIG. 8 shows an illustrative example of a subterranean aircraft tug pathway.

### SPECIFIC DESCRIPTION

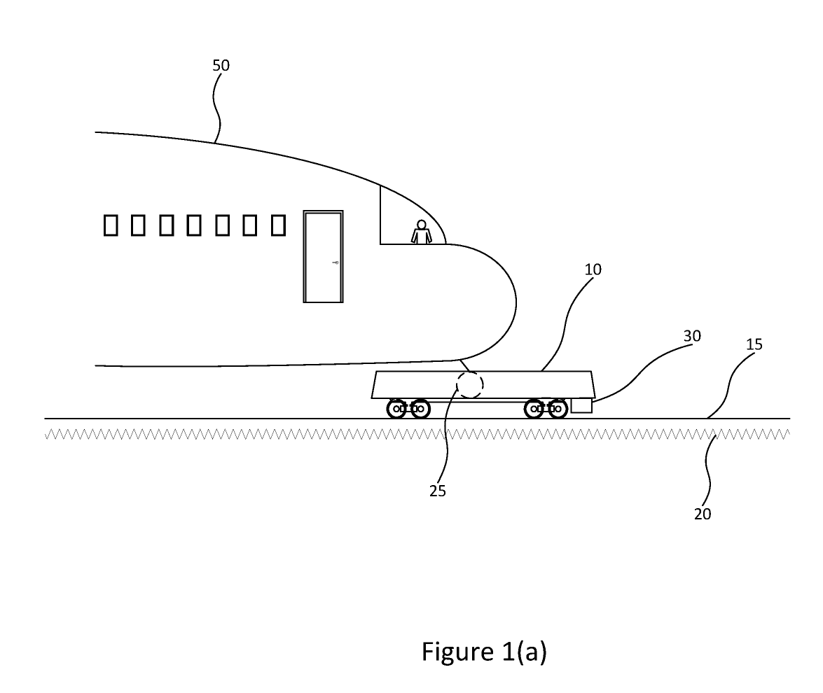

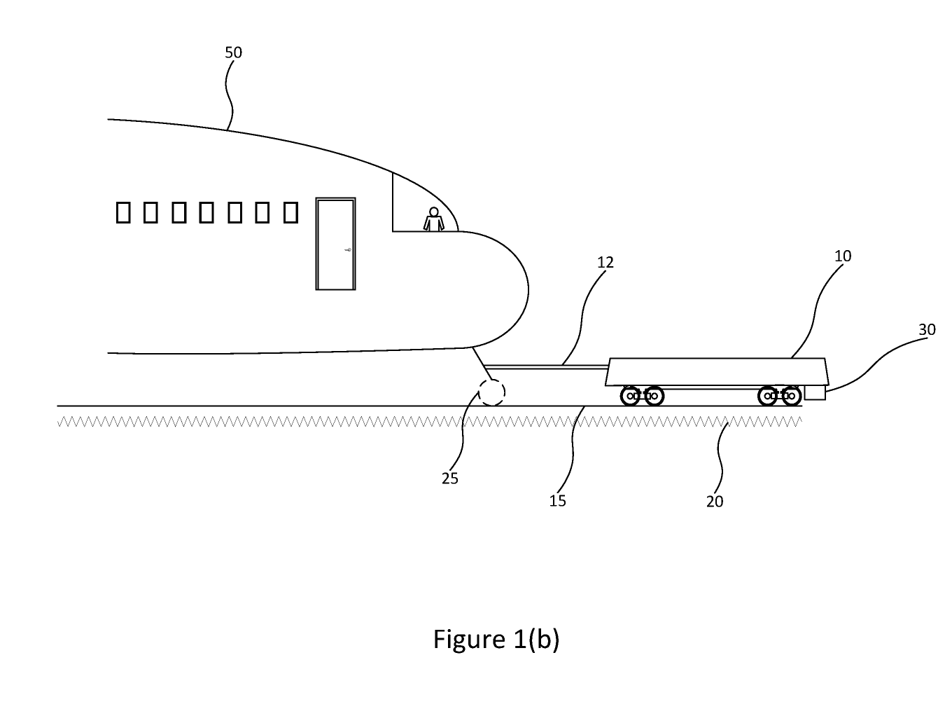

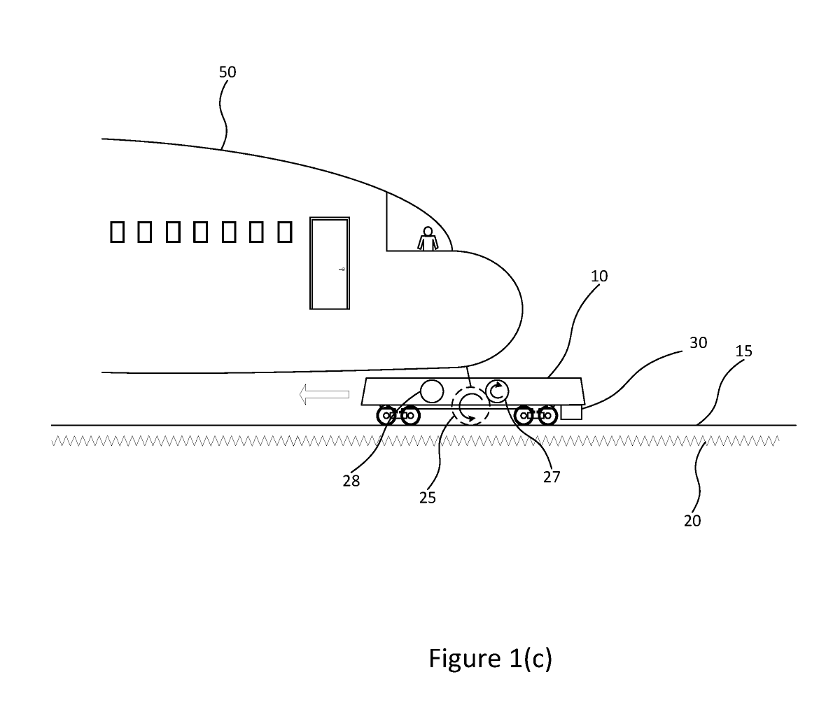

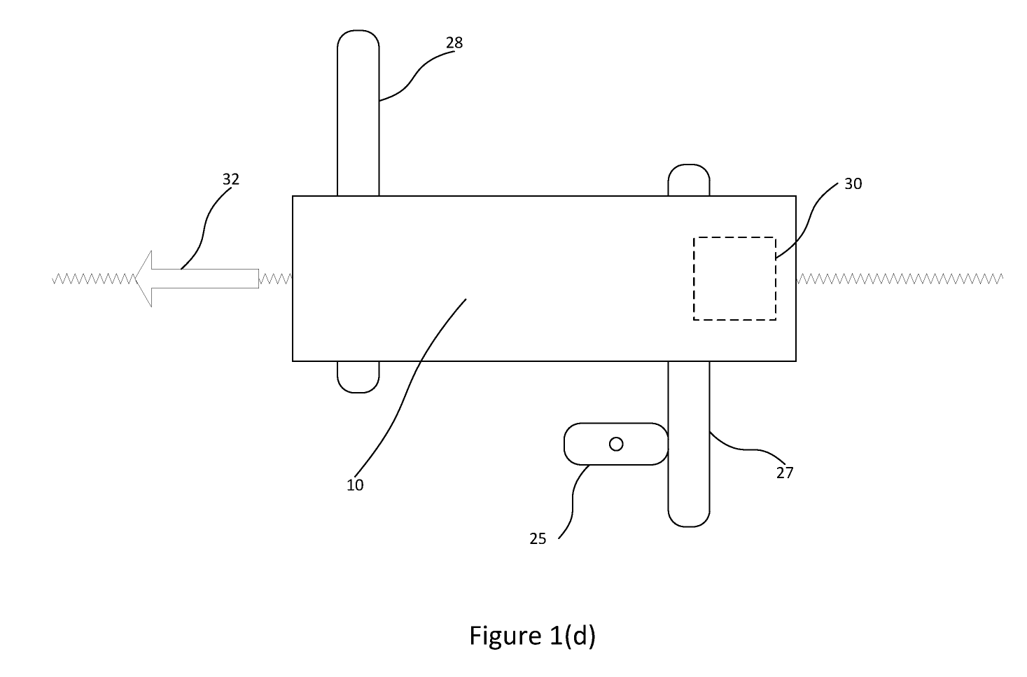

Referring to FIG. 1a, aircraft 50 are typically parked on stands or bays next to a terminal some distance from a runway 15; when an aircraft 50 is required for use, it is towed or transported towards the taxiway or start of the runway 15, so that they might use the runway 15 to take off. Or, alternatively, once an aircraft 50 has landed on a runway 15 it may require manoeuvring back to the terminal area. The foremost wheel or set of wheels of the aircraft 25 (referred to as a ‘nose wheel’) is coupled to an aircraft tug 10 (referred to as a ‘pushback tug’, ‘tug’, ‘tractor’, or ‘taxi vehicle’) operable to tow the aircraft 50 to a required destination. In the example shown, the nose wheel 25 is coupled to the tug by the wheel arrangement being clamped to or on a platform within the aircraft tug 10. Alternatively, as shown in FIG. 1b, the aircraft tug 10 could attach a tow bar 12 (or similar device) to the wheel arrangement 25 and tow the aircraft 5. The latter may be a simpler arrangement, but may introduce fatigue stresses on the wheel arrangement 25, particularly if there is frequent stopping and starting of the aircraft tug 10. The arrangement shown in FIG. 1b is the more common arrangement.

In the example shown in FIGS. 1a and 1b, the aircraft tug 10 is equipped with an inductive powering assembly 30. The inductive powering assembly 30 allows the vehicle 10 to be powered while in operation, provided it stays within proximity of an inductive powering strip 20. The inductive powering strip 20 is adapted to be provided in association with the taxiway 15, for example by embedding it a small distance below the surface of the taxiway or affixing it on top of the runway 15. Inductive power allows the aircraft tug 10 to be continuously powered when in the vicinity of the strip 20 without the need for any on-board power source.

As shown in FIG. 1c, an alternative aircraft tug 10 is equipped so as to obviate the need for a platform to which an aircraft nose wheel 25 is coupled, or a tow bar 12. The tug 10 comprises a roller 27 positioned closer to the rear of the aircraft tug 10 than the front. The positioning of this roller 27 allows for more controlled manoeuvring of the aircraft tug 10. When the aircraft 50 is required to move backwards, the roller 27 is engaged with the nose wheel 25. The roller 27 then rotates along its longitudinal axis in such a direction so as to cause the nose wheel 25 to rotate in a direction to move the aircraft 50. When the aircraft 50 is required to move forwards, the aircraft tug 10 can be re-orientated and rotated substantially 180 degrees so as to position the front of the aircraft tug in the substantially same direction as the aircraft 50. The roller 27 may then be placed behind and engaged with the nose wheel 25 such that when the roller 27 is rotated the aircraft 50 is moved forwards.

In an alternative embodiment a second roller 28 is provided. The aircraft tug 10 therefore does not need to re-orientate itself in order to move the aircraft 50 forwards. The second roller 28 can be engaged with the nose wheel 25. The second roller 28 then rotates along its longitudinal axis in such a direction so as to cause the nose wheel 25 to rotate in a direction to move the aircraft 50 forwards.

In one embodiment, the rollers 27, 28 are provided with a surface operable to grip the tread of a tire of an aircraft nose wheel 25. The rollers in one example are metallic, or made of hard rubber. The surface comprises a number of individual raised protrusions, arranged in a series of rows along the longitudinal length of the rollers 27, 28. As the rollers 27, 28 rotate, each row of protrusions engages with the tire and generates a rotation in the opposite direction to that of the rollers 27, 28.

The diameter of each roller 27, 28 may depend on application (for example, the size of the aircraft to be moved, and the size of the tire). A smaller diameter roller may be able to provide a lower effective gear ratio thereby reducing the torque required to rotate it, but a roller with a small diameter may be less effective at gripping the tire. In one example, the diameter of the roller is between 5 cm and 50 cm, preferably between 10 cm and 25 cm. Each of the rollers 27, 28 is inductively powered (described in more detail below).

In order to engage with the nose wheel 25, the rollers 27, 28 protrude from the side of the aircraft tug 10. The rollers 27, 28 then couple to the nose wheel 25 at a sufficient distance from the aircraft tug 10 so as to avoid potentially damaging physical contact between the aircraft tug 10 and the nose wheel 25. A greater distance of protrusion allows for a greater degree of flexibility in where the tug 10 couples to the nose wheel 25, but may make the arrangement more susceptible to fatigue. In one example the protrusion of each roller 27, 28 is between 0.5 m and 3 m, preferably between 1 m and 2 m, as measured from the body of the aircraft tug 10 to the longitudinal end of the roller.

FIG. 1d shows an aerial view of an aircraft tug 10 equipped with first and second rollers (27, 28). In this embodiment, the rollers (27, 28) are offset from the tug 10. The tug 10 may therefore operate offset from the line of travel of the aircraft. During movement of the aircraft 50, the tug 10 and inductive powering assembly 30 pass over the inductive powering strip 20, thereby allowing the aircraft tug 10 to be continuously powered when in the vicinity of the strip 20. However the nose wheel 25, and therefore at least a portion of the weight of the aircraft 50, does not pass directly over the strip 20, thereby helping to prevent damage from undue wear from repeated passage of aircraft. The first roller 27 engages with the nose wheel 25 so as to bodily move the aircraft 50 parallel to the line of travel of the tug 10, in a direction indicated by the arrow 32. If the aircraft 50 is to be moved in the opposite direction, then the second roller 28 can be engaged with the nose wheel 25 so as to move the aircraft 50 in the opposing direction.

Taxiways around runways are typically very flat, constructed to tight tolerances to be flat and level and are kept free of snow, standing water and other obstructions which may otherwise necessitate a high ground clearance. This means that the inductive powering assembly 30 on an aircraft tug 10 can be placed near the powering strip 20 thereby increasing the efficiency of the power transfer. In one example, the clearance between the inductive powering assembly and the ground is less than 50 cm. In another example, the inductive powering assembly is between 5 cm and 30 cm from the ground. In another example, the inductive powering assembly is less than 20 cm, or 10 cm from the ground.

The inductive powering strip 20 may also be operable to provide power to trace heating elements embedded in the runway 15 or taxiway 35 to help prevent the build up of ice or snow.

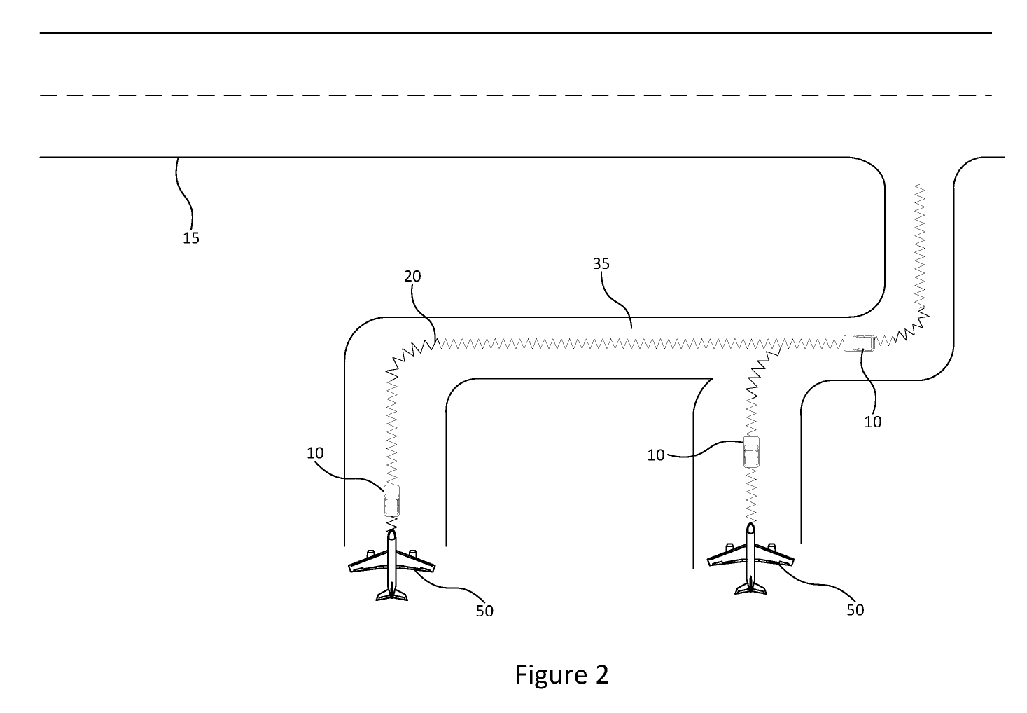

FIG. 2 illustrates an aerial view of an example aircraft taxiing system (not to scale). An aircraft 50 is stationed adjacent a section of the taxi path 35. The taxi path 35 comprises an inductive powering strip 20. The aircraft tug 10 is operable to tow an aircraft 50 to/from the runway 15. While the aircraft tug 10 is travelling along the taxi path 35 it is inductively powered by the powering strip 20, thereby eliminating the need for any refuelling or charging. Alternative routes, passing loops, and/or sidings may also be provided so that aircraft tugs 10 can pass one-another.

In one example, the inductive powering strip 20 is selectively powered so that only the section that an aircraft tug 10 is travelling on is powered. This improves the efficiency of the system and provides a method of control the movement of aircraft tugs 10. The system may comprise means for determining the location of the aircraft tug 10 so as to determine which section of the strip to selectively power. Knowledge of the position of the aircraft tugs also allows for easier centralised traffic management and resource utilisation (e.g. the location of the nearest vacant aircraft tug 10).

In one example, the means for determining the location of the aircraft tug 10 is in the form of one or more fixed sensors on or around the taxiway 35, for example: pressure pads, switches, light reflecting/beam sensors, magnetic sensors, Hall-effect sensors, or light beams. In another example, the means for determining the position of the aircraft tug 10 may comprise on-board sensors adapted to sense position-determining features on the taxiway 35, such as markings or magnetic elements. Alternatively or in addition, the aircraft tug 10 may comprise sensors such as: a Global Positioning System (GPS) unit, dead-reckoning sensor (e.g. an accelerometer), and/or a camera so as to aid in determining its position. Such sensors may be coupled with a transmitter unit so as to transmit information relating to its location (and other data) to a central management system.

During taxiing operations, the pilot in command has responsibility for safe movement of the aircraft across the airport. The pilot therefore remains in command by being able to operate the speed and/or braking of the tug 10 remotely. In one embodiment, the strip 20 defines the direction the tug 10 travels, without external steering input required.

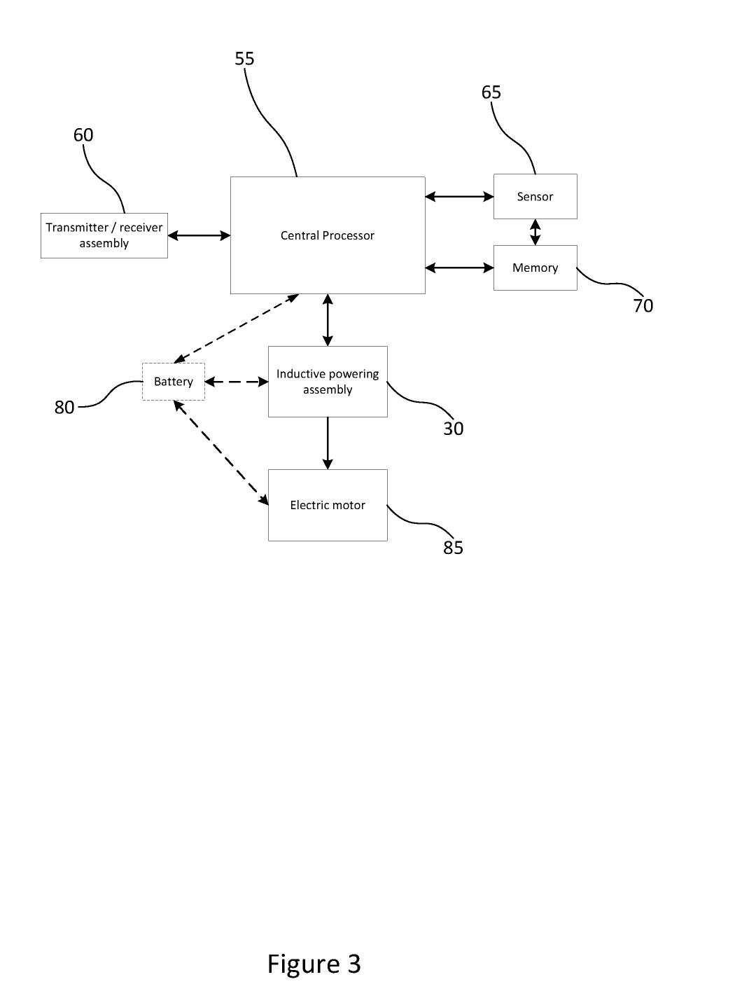

FIG. 3 illustrates a schematic diagram of the components within an inductively powered aircraft tug 10. An inductive powering assembly 30, for example in the form of a pick-up coil, allows the vehicle 10 to be inductively powered while in operation. A central processor 55 monitors the state of the vehicle 10, and gathers and processes information provided from other components. A sensor 65 and memory 70 are coupled to the central processor 55, as well as to each-other. The sensor, coupled with the central processor 55, detects where an inductive powering strip 20 is located, and therefore keeps the tug 10 travelling on the correct path. The sensor 65 may take the form of determining the position of peak inductance between the inductive powering assembly 30 and the strip 20. This may take the form of manoeuvring the tug 10 and determining if inductance has increased or decreased, and repeating until a peak (or a value above a predefined threshold) is found. Alternatively, or in addition, the sensor 65 may take the form of a digital camera alongside image recognition software, a magnetic sensor, or may be combined with a sensor operable to determine the position of the aircraft tug as described above. Two or more means of determining the position of the tug 10 in relation to the strip 20 provides a level of redundancy in the event of one method failing (for example, a digital camera may get dust on its lens).

The location of a strip 20 may be pre-loaded in the memory 70 and/or added to memory when detected, allowing the central processor 55 to locate them more quickly and efficiently in the future. A transmitter/receiver assembly 60 allows the central processor 55 to receive commands from a control unit, allowing for external control of the vehicle 10. Such commands may be transmitted wirelessly using radio, WiFi®; or via a wired connection. The transmitter/receiver assembly 60 further allows the central processor to transmit a message, for example if an accident occurs or any unexpected situation which would require intervention. In one example, the speed of the aircraft tug 10 is controlled by a pilot issuing instructions using a corresponding transmitter in the aircraft cockpit, but the path taken is determined by the aircraft tug 10. This allows the pilot to ground control movement of the aircraft whilst ensuring the aircraft tug 10 does not stray off track. Such control by a pilot may also be reserved for key junctions (e.g. joining another taxi path, or starting movement); this would allow the pilot to concentrate on other matters whilst the aircraft is taxiing without compromising safety. The processor 55 determines whether the tug 10 should be controlled by a pilot, or by a central controller. In one example, the tug 10 comprises means for determining whether the tug 10 is coupled to an aircraft, and it is only controllable by a pilot if it is coupled to an aircraft. The means for determining whether the tug 10 is coupled to an aircraft may comprise a switch which is activated, or an electrical circuit which is completed, when the tug 10 is coupled to an aircraft.

Data may be provided to/from the transmitter/receiver assembly 60 on the aircraft tug 10 via a data cable provided in the runway 15. Periodic transmissions could transmit data relating to movement instructions, and provide data relating to the position and status of the aircraft tug to a control unit. Such transmissions may occur via short-range wireless technologies such as Bluetooth®, Near Field Communication (NFC), or ZigBee® to a receiver on the aircraft tug 10.

The inductive powering assembly 30 is operable to use the power provided through the strip 20 and use it to power an electric motor 85, thereby propelling the vehicle 10. If the vehicle 10 is temporarily not travelling over a strip 20, then power will not be provided to the electric motor 85, and the vehicle 10 will stop. However in an alternative example, the inductive powering assembly 30 is operable to use the power provided through the strip 20 and use it to charge a battery 80. The battery 80 then powers the electric motor 85. The battery may be continuously recharged when the vehicle 10 is travelling over a strip 20. If the vehicle 10 is temporarily not travelling over a strip 20, or a portion of the strip is faulty, then the battery 80 may power the electric motor 85 and therefore power the vehicle 10 until such a strip 20 can be re-joined.

Alternatively, the battery 80 may be in place merely to provide power to the central processor 55 and associated components so that, for example, error messages can be sent in the event of loss of power from the inductive strip 20.

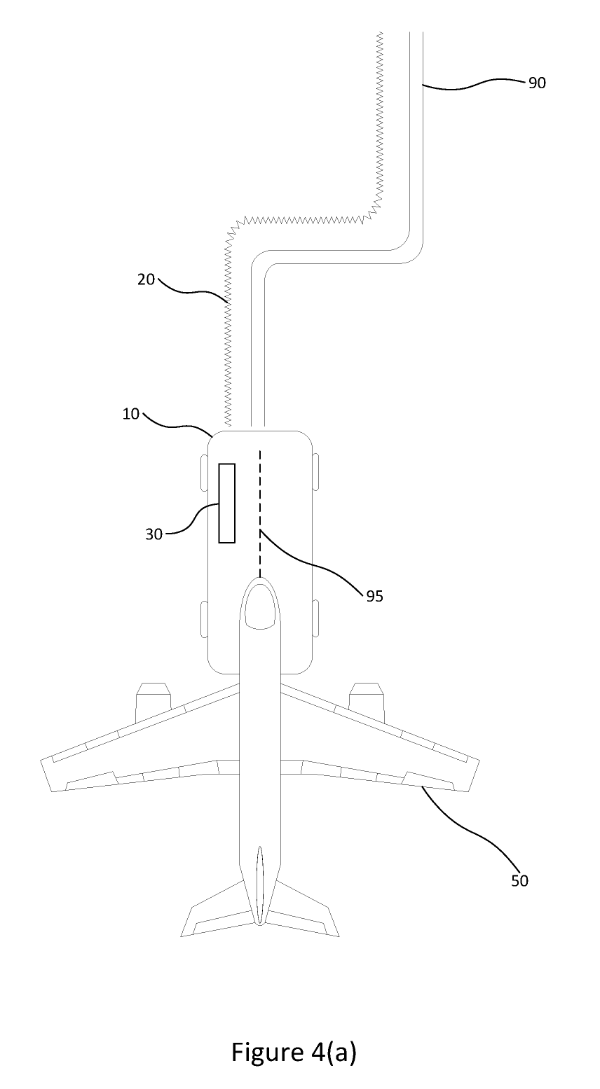

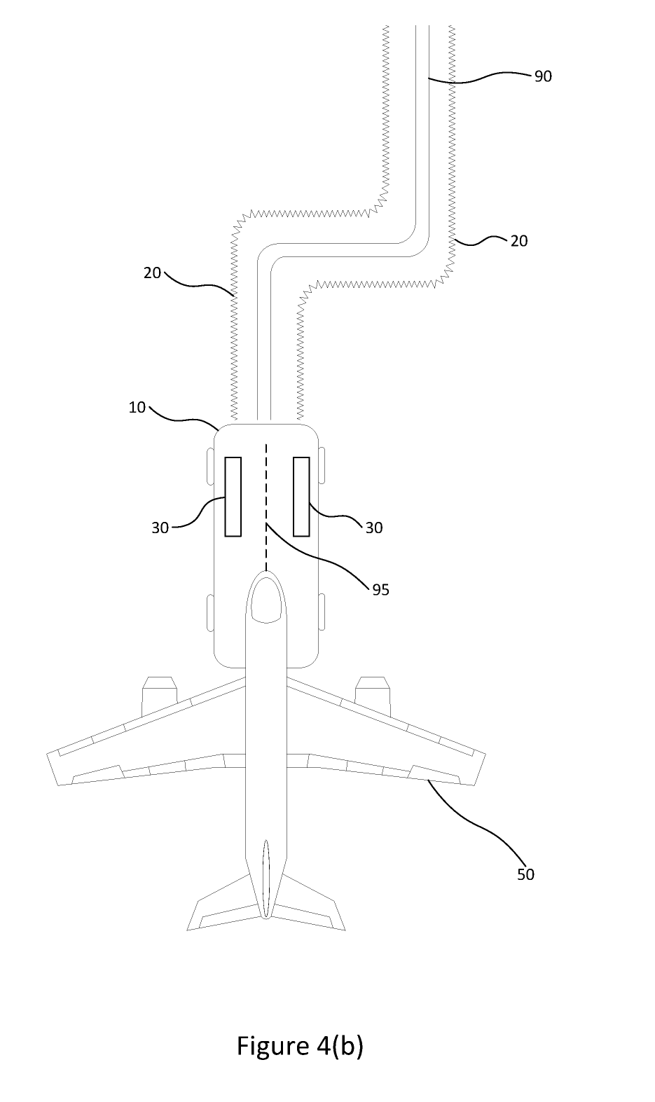

The inductive powering strip 20 does not necessarily need to pass centrally beneath the vehicle 10. As shown in FIG. 4(a) an alternative example of the system (not to scale) comprises a strip 20 being offset from an aircraft nose-wheel line 95. The corresponding inductive powering assembly 30 on the underside of the aircraft tug 10 is similarly offset, so that it remains as close to the strip 20 as possible. In use, the weight of the aircraft 50 therefore does not pass directly over the strip 20, thereby helping to prevent damage from crushing and repeated wear. Forming a shallow trench and embedding an inductive powering strip 20 may weaken that part of the taxiway; offsetting the inductive powering strip from the section supporting the weight of an aircraft would reduce the impact of any weakening. A separate line indicating the location of the inductive powering strip 20 may be provided on the taxiway, providing the tug 10 with an identifying mark to follow. Alternatively, or in addition, the aircraft tug 10 may utilise the existing nose wheel line 90 as a guide.

In the example shown in FIG. 4(b) two inductive powering strips 20 are provided and two corresponding inductive charging assemblies 30 are provided on the underside of the aircraft tug. If the tug 10 diverts from the course, say by veering to the left, then the right hand charging assembly 30 will be over the left hand strip 20, so a limited amount of power may still be drawn and the vehicle 10 able to power itself back to its proper course.

The inductive powering strips 20 are offset from the nose wheel line 90 by an amount so that in normal use the nose wheel does not roll over it (i.e. the inductive powering strip 20 is not within the area in which a nose-wheel typically contacts the taxiway). This requirement sets a minimum amount of offset as being at least half a width of an aircraft nose-wheel assembly. The amount of offset is preferably not so much so that the main landing gear under the wing of the aircraft rolls over the strip. The width of the aircraft tug 10 also imparts a maximum distance the strip could be offset from the nose wheel line 90. Therefore, a suitable offset would be between 0.1 m and 3 m, preferably between 0.2 m and 2 m; more preferably between 0.5 m and 1 m.

Conventionally, the integrated propulsion system of the aircraft, (e.g. a jet engine, or propellers), is used to power the aircraft 50 to the start of the runway 15. The use of the integrated propulsion system allows the engines to ‘warm up’, as they cannot be used from stationary straight to high power without risk of damage to the aircraft 50. The warming up process, also referred to as ‘spooling up’, allows the engines to stabilise at a particular speed, ensuring that the thrust on the aircraft is constant and balanced. As discussed above, such a method represents an inefficient use of fuel and contributes to pollution, and in particular particulate pollution which is harmful to ground operatives who typically operate near terminals. Such pollution can include the release of soot and sulphate particulates, which are harmful if inhaled.

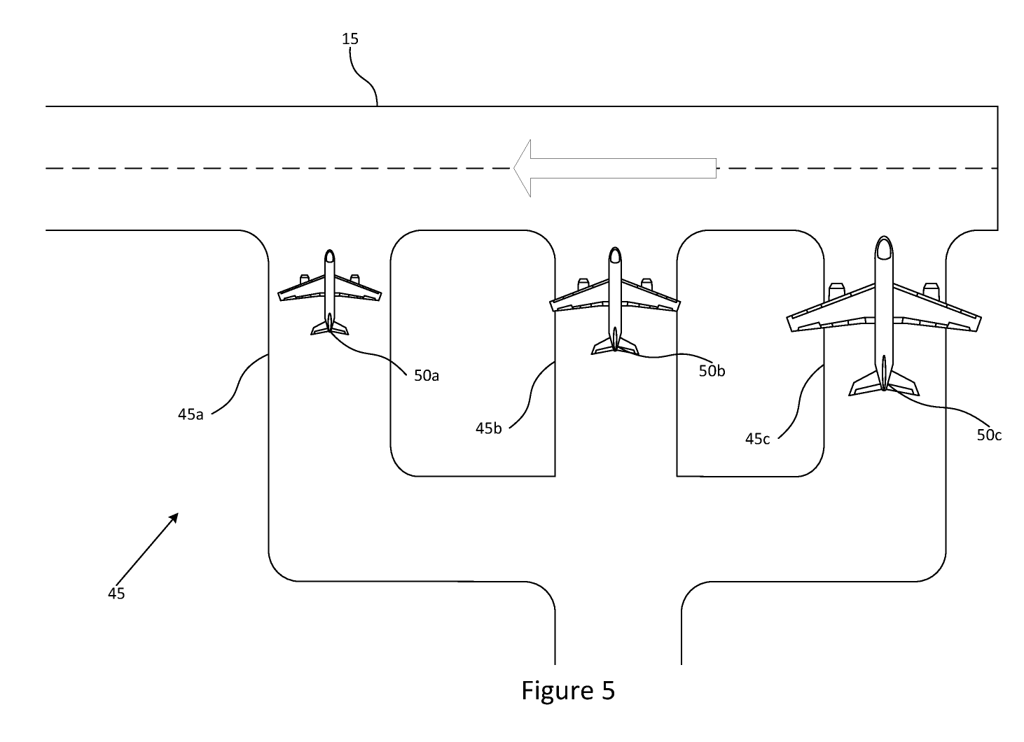

FIG. 5 shows a runway arrangement comprising a staging area 45 adjacent to the runway 15. Aircraft 50 are towed to this staging area 45 (for example, by an inductively powered aircraft tug 10 as described above) prior to taking off. The placement of aircraft 50 in a staging area allows aircraft to queue and ‘spool up’ their engines in an individual bay. The queuing paths from each bay to the runway are independent of one-another, meaning that if a fault with an engine is discovered, the aircraft can abort taking off without impacting the ability for other aircraft to access the runway, as would be the case in single-file (communal) taxiway access to a runway. In one example, the taxiways 35 are arranged so that aircraft are able to return to the terminal without conflicting with other departing aircraft. In such a way, the use one bay (or queuing path) does not affect the use of another bay (or queuing path).

Providing such a staging area 45 allows for aircraft to be towed into position ready for take-off prior to a restriction on aircraft noise (for example early in the morning), and then take-off as soon as this restriction is lifted. Such an advantage is magnified when combined with the inductive taxiing system described above; aircraft can be positioned in place ready to take off with significantly less noise (and pollution) prior to the first take-off slot of the day. Such a method allows for the first take-off to be substantially earlier, thereby increasing the total number of possible departures per day.

FIG. 5 shows aircraft 50a, 50b, 50c arranged adjacent the runway 15 in corresponding bays 45a, 45b, 45c. The arrangement is in order of the amount of wake turbulence they produce, from the least to the most. Larger, more heavily laden aircraft typically produce more wake turbulence than smaller, lighter aircraft. The bays 45 may be sized according to the size of the aircraft that is to wait in the bay. In such a way, neighbouring bays are different widths. This allows for a more compact arrangement, and reduces the chance of a large aircraft inadvertently entering a bay intended for a small aircraft (or vice versa). The aircraft 50a, 50b, 50c then spool up their engines next to the runway, as is required before flight. The aircraft 50a producing the least wake turbulence takes off first, followed by the other aircraft 50b, 50c respectively. In such a manner, small and/or light aircraft 50a are less likely to be adversely affected by wake turbulence from larger/heavier aircraft 50b, 50c, and as such do not need to wait for the turbulence to clear before taking off. This increases the number of aircraft 50 using the runway 15 in a given time period.

The bay 45a utilised by the smaller/lighter aircraft 50a is shown positioned further down the runway in the direction aircraft move to take off. This is because such aircraft 50a typically require a shorter runway to take off than larger/heavier aircraft 50c.

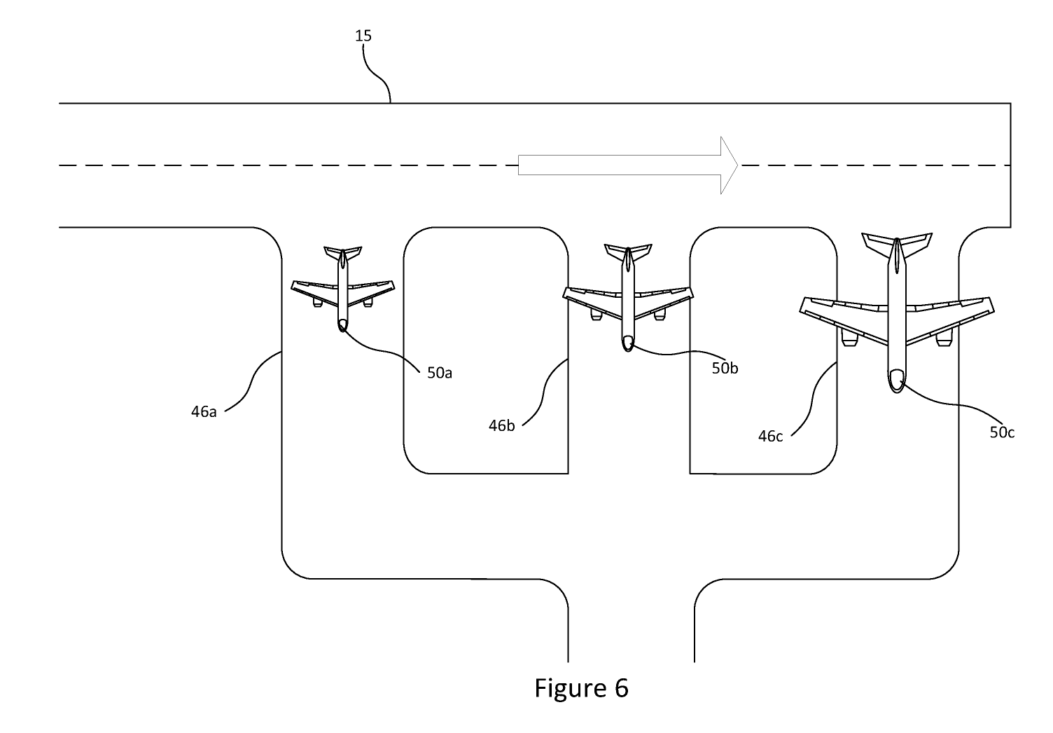

FIG. 6 shows a similar arrangement to that of FIG. 5, but showing the opposing end of the runway comprising a staging area 46 for aircraft 50 having recently landed. Such a staging area allows aircraft to depart the runway quickly, avoiding the possibility of encountering a queue on the taxiway. Furthermore, engines require time to shut down following landing, this area allows for such a procedure to be undertaken in a controlled manner.

FIG. 6 further shows aircraft 50a, 50b, 50c arranged adjacent the runway 15 in corresponding bays 46a, 46b, 46c. The arrangement is in order of the length of runway required to come to a safe stop (which typically corresponds to the size or weight of the aircraft).

Following landing and entering their respective bays 46, the aircraft 50 wait for an aircraft tug 10 to pick them up and tow them to the terminal. This avoids the need for aircraft 50 to use their own power to taxi, and thereby prolonging the time in which the engines are powered, leading to increased fuel use, pollution, and engine wear. In one example, the taxiing is performed using the inductive taxiing method as described above.

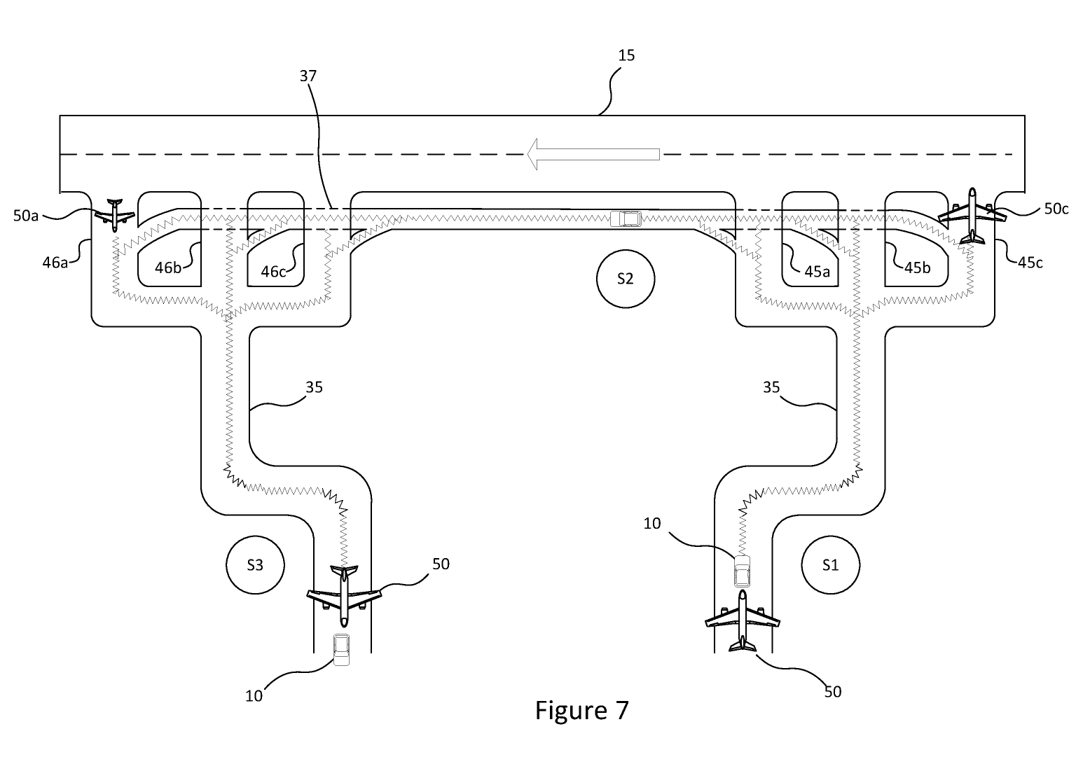

FIG. 7 shows example movements of an aircraft tug 10. In step 1 (‘S1’), an aircraft tug 10 tows an aircraft to the staging area 45 near to the runway 15. It then departs, in step 2 (‘S2’) and makes its way to the opposite end of the runway via an aircraft tug pathway 37 running substantially parallel to the runway 15 so as to ‘pick up’ an aircraft which has recently landed (or about to land). In step 3 (‘S3’), the aircraft tug 10 tows the aircraft back to a terminal. The process may then continue by the aircraft tug 10 towing another aircraft 50 to/from the runway 15. Because the tugs are low height they can operate close to the runway without infringing obstacle surfaces. Each departing staging area 45 or arriving staging area 46 may be provided with a separate aircraft tug pathway 45 so as to enable the aircraft tug 10 to more easily relocate to another staging area if required.

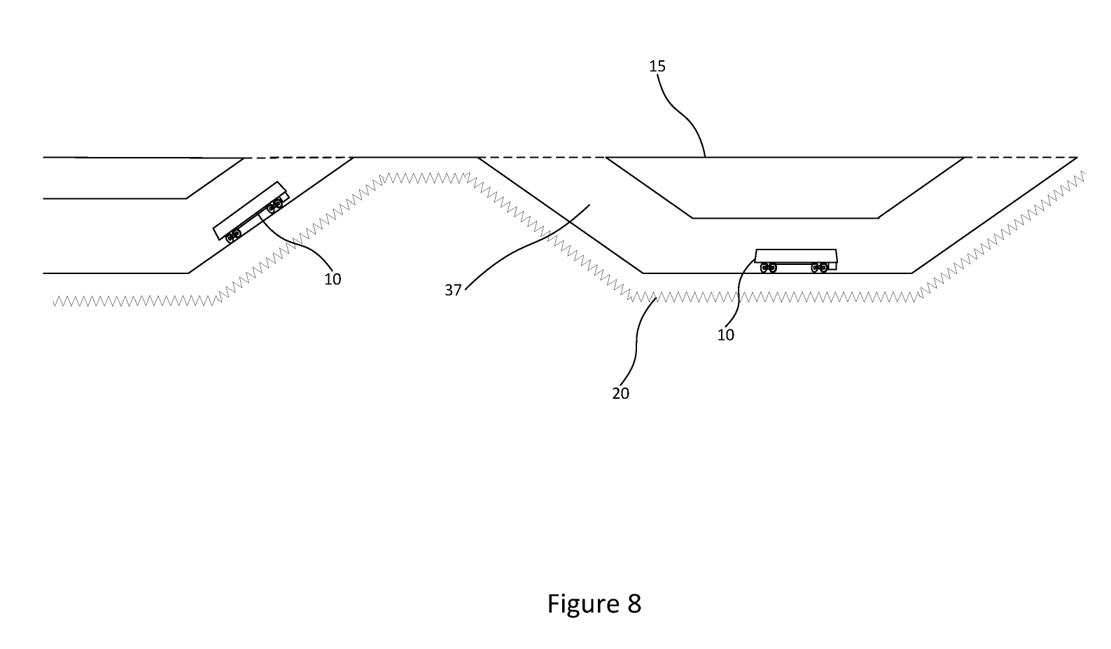

FIG. 8 shows an illustrative example of a subterranean aircraft tug pathway. At least a portion of aircraft tug pathway 37 may be subterranean so as to not interfere with other airport movements (for example other aircraft). In one example, the aircraft tug 10 goes into an underground tunnel after towing an aircraft 50 to the runway 15. The aircraft is not towed through the tunnel; in one example, the tunnel is dimensioned so that a low height aircraft tug can drive through, it being approximately 1 m-4 m high, preferably between 2 m-3 m. The tunnel may be single width, or double width so as to allow aircraft tugs 10 to pass one-another; the width may therefore be between 2 m-6 m for single width, or 4 m-12 m for double-width.

In such a way, the aircraft tugs 10 can quickly and easily move out of the way of any aircraft waiting to depart. The aircraft tug pathway 37 may return above ground when sufficiently far from the aircraft departing staging area 45 and travel to the aircraft arrival staging area 46 where it would go underground and return above ground near the aircraft 50 it is intending to tow back to the terminal.

In an alternative example, the entire aircraft tug pathway 37 is underground.

### Alternatives and Modifications

Various other modifications will be apparent to those skilled in the art, for example, the aircraft tug 10 may not be powered exclusively via inductive charging. The vehicle may comprise a solar panel, providing further electrical power, which may be used to charge a battery 80, or directly power the motor 85. The vehicle 10 may also comprise a kinetic energy recovery system (KERS), wherein energy can be recovered from the vehicle 10 braking (for example, to charge a battery, or to transfer power to a flywheel).

The inductive powering strip 20 may be provided in association with the taxiway, apron or runway by way of it being affixed on top of the surface as opposed to it being placed under the surface. Such an arrangement may be more susceptible to damage, but would be cheaper, faster, and simpler to implement, as well as allowing for more efficient power transfer.

The underground portion of the aircraft tug pathway 37 may be in the form of a loop back onto another location on the inductive powering strip 20. In such a way, aircraft tugs 10 are able to loop around the aircraft 50 they have just dropped off without interfering with the subsequent movement of that aircraft 50.

It should be appreciated that FIG. 7 shows a single runway arrangement whereas other arrangements are possible. For example, there may be two (or more) runways disposed parallel to one-another. In such an example, an aircraft tug 10 may switch between the various runways when dropping off or picking up aircraft 50. Corresponding additional or alternative aircraft tug pathways 37 may therefore be provided.

Sensors on the aircraft tugs 10, or the taxiway 35 may be used for additional purposes above determining the location of an aircraft tug 10. A digital camera on the aircraft tug 10 or associated with the taxiway may be used to detect damage to the taxiway 35 and/or inductive powering strip 20, or to indicate the location of standing water (or other obstruction) which may require attention.

Furthermore, further functionality may be provided alongside the powering strip 20, for example, a trace heating element may be provided so as to ensure that the taxi area used by the tug 10 is kept clear of ice and snow. This can use in part some of the heat generated by the induction charging process.

It will be understood that the present invention has been described above purely by way of example, and modifications of detail can be made within the scope of the invention. In particular, aspects of the invention may be provided independently of one another; for example, the ‘staging area’ may be provided independently of the inductively powered aircraft tugs.

Reference numerals appearing in the claims are by way of illustration only and shall have no limiting effect on the scope of the claims.

1. A system for inductively powering an aircraft tug, the system comprising:
an inductive powering strip adapted to be provided in association with a taxiway;
said inductive powering strip defining a path for an aircraft tug.

2. A system according to claim 1, further comprising means for selectively powering a section of said inductive powering strip.

3. A system according to claim 1 or 2 further comprising means for determining the position of an aircraft tug.

4. A system according to claim 3 wherein the means for determining the position of an aircraft tug comprises sensors adapted to be provided in association with said taxiway.

5. A system according to any preceding claim wherein said inductive powering strip is adapted to be embedded within a taxiway.

6. A system according to any preceding claim, further comprising a taxiway, wherein said path for an aircraft tug follows an aircraft taxi path.

7. A system according to claim 6, wherein said inductive powering strip is offset from an aircraft nose-wheel line.

8. A system according to claim 6 or 7 comprising a second inductive powering strip offset from said inductive powering strip.

9. A system according to claim 8 wherein said inductive powering strip and said second powering strip are disposed either side of an aircraft nose-wheel line.

10. A system according to any of claims 7 to 9 wherein said inductive powering strip and/or said second powering strip is offset from the aircraft nose-wheel line by between 0.1 and 3 m; preferably between 0.2 m and 2 m; and more preferably between 0.5 m and 1 m.

11. A system according to any preceding claim wherein said path comprises markings on said taxiway adapted to be detected and followed by an aircraft tug.

12. A system according to claim 11 wherein said markings comprise a line.

13. A system according to any preceding claim, wherein said path comprises a path to an area in which aircraft access a runway.

14. A system according to any preceding claim, wherein said path comprises a path from an area in which aircraft depart from a runway.

15. A system according to any preceding claim, further comprising a subterranean path for an aircraft tug.

16. A system according to claim 15 wherein said subterranean is between 1 m-4 m in height, preferably between 2 m-3 m in height.

17. A system according to claim 15 or 16 wherein the subterranean path is between 2 m-12 m in width.

18. A system according to any of claims 15 to 17, wherein said subterranean path is provided at a location so as to circumvent an obstacle.

19. A system according to claim 18 wherein said subterranean path is provided at a location to circumvent an area in which aircraft move; an area in which other tugs move; or airport infrastructure.

20. A system according to claim 18 or 19 wherein said subterranean path is from an end of the taxi path at an area in which an aircraft accesses a runway.

21. A system according to any preceding claim further comprising means for aircraft tugs to pass one another.

22. A system according to claim 21 wherein said means for aircraft tugs to pass one another comprise at least one sidings or a passing loop.

23. A system according to any preceding claim further comprising means for controlling an aircraft tug operating within the system.

24. A system according to claim 23 wherein said controlling means comprises a controller in a cockpit of an aircraft.

25. A system according to claim 23 or 24 wherein said controlling means comprises a central controller.

26. A system according to any of claims 23 to 25 wherein the system is adapted to switch between two control means in dependence on whether the tug is coupled to an aircraft.

27. A system according to any of claims 23 to 25 wherein said controlling means is adapted to wirelessly control one or more aircraft tugs using said system.

28. A system according to any preceding claim further comprising a heating element following the same path as said inductive powering strip.

29. A system according to claim 28 wherein said heating element is adapted to utilise heat generated from said inductive powering strip.

30. A system according to any preceding claim incorporated into an airport taxiway arrangement.

31. A system according to any preceding claim incorporated into an airport runway arrangement.

32. A system according to any preceding claim incorporated into an airport.

33. A system according to any preceding claim further comprising an aircraft tug vehicle.

34. An aircraft tug comprising means to be inductively powered.

35. An aircraft tug according to claim 34 being driverless.

36. An aircraft tug according to claim 34 or 35, comprising means for following a predefined path.

37. An aircraft tug according to claim 36, wherein said means for following a predefined path comprises means for determining a peak inductance.

38. An aircraft tug according to claim 36 or 37, wherein said means for following a predefined path comprises a computer vision system adapted to detect markings on a taxiway.

39. An aircraft tug according to claim 38 wherein said markings comprise a line on said taxiway.

40. An aircraft tug according to any of claims 34 to 39 further comprising means for steering the aircraft tug to said predefined path.

41. An aircraft tug according to any of claims 34 to 40, wherein said means to be inductively powered comprises a pick up coil on the underside of the tug.

42. An aircraft tug according to claim 41, wherein said pickup coil is offset from the centre of the tug.

43. An aircraft tug according to claim 42 wherein said pickup coil is offset from the centre of the tug by between 0.1 and 3 m; preferably between 0.2 m and 2 m; and more preferably between 0.5 m and 1 m.

44. An aircraft tug according to any of claims 34 to 43 comprising a first and a second means to be inductively powered.

45. An aircraft tug according to claim 44, wherein first and a second means to be inductively powered each comprise a pick up coil on the underside of the tug.

46. An aircraft tug according to claim 41 or 42, wherein said pick up coil is less than 50 cm from the ground.

47. An aircraft tug according to claim 46, wherein said pick up coil is less than 20 cm from the ground.

48. An aircraft tug according to claim 46, wherein said pick up coil is between 10 cm and 30 cm from the ground.

49. An aircraft tug according to any of claims 34 to 48 comprising means for determining its location.

50. An aircraft tug according to claim 49 wherein said means for determining its location comprises means for receiving data.

51. An aircraft tug according to claim 49 or 50 wherein said means for determining its location comprises sensors adapted to sense position-determining features on said taxiway.

52. An aircraft tug according to any of claims 34 to 51 comprising a receiver module adapted to receive instructions from a controller.

53. An aircraft tug according to any of claims 34 to 52 comprising means for determining that the tug is coupled to an aircraft.

54. An aircraft tug according to claim 53 comprising means for switching control of the tug in dependence on whether it is coupled to an aircraft; preferably wherein said control is from said aircraft when coupled, and from a central controller when not coupled.

55. An aircraft tug according to any of claims 34 to 54 comprising one or more rollers operable to engage with a nose wheel of an aircraft, wherein the rotation of the one or more rollers is operable to generate a rotation of the nose wheel of said aircraft.

56. An aircraft tug according to claim 55 wherein the longitudinal axis of the one or more rollers is substantially parallel to the axis of rotation of the nose wheel of said aircraft.

57. An aircraft tug according to claim 55 or 56 wherein the rotation of the one or more rollers is sufficient to bodily move an aircraft.

58. An aircraft tug according to any of claims 55 to 57 wherein the longitudinal axis of the one or more rollers is positioned closer to the rear than the front of the aircraft tug.

59. An aircraft tug according to any of claims 55 to 58 wherein the one or more rollers protrudes from the aircraft tug.

60. An aircraft tug according to claim 59 wherein the one or more rollers protrudes more from one side of the aircraft tug than the other.

61. An aircraft tug according to any of claims 55 to 60 comprising two rollers.

62. An aircraft tug according to claim 60 or 61 wherein the two rollers protrude from opposing sides of the aircraft tug.

63. An aircraft tug according to any of claims 34 to 62, for use in the system of any of claims 1 to 33.

64. A method of inductively powering an aircraft tug, the method comprising the steps of:
powering an inductive powering strip provided in a taxiway;
said strip defining a path for an aircraft tug.

65. A method according to claim 64 further comprising the step of controlling one or more aircraft tugs.

66. A method according to claim 65 wherein said controlling comprises transmitting a control signal wirelessly to said one or more aircraft tugs.

67. A method according to any of claims 64 to 66 wherein said strip provided in the taxiway is selectively powered.

68. A method according to claim 67 wherein said inductive powering strip provided in the taxiway is selectively powered in dependence on the location of an aircraft tug.

69. A method according to any of claims 64 to 68 further comprising the step of determining the location of one or more aircraft tugs.

70. A method according to any preceding claim for use in an airport taxiway arrangement.

71. A method according to any preceding claim for use in an airport runway arrangement.

72. A method according to any preceding claim for use in an airport.

73. An aircraft taxiway arrangement comprising a subterranean path for an aircraft tug.

74. An aircraft taxiway arrangement comprising:
an area adjoining a runway comprising a plurality spaces for aircraft to queue;
each space comprising a path between said runway and a taxiway; wherein
each path is independent of one another.

75. An aircraft taxiway arrangement according to claim 74, wherein said taxiway leads to or from a terminal.

76. An aircraft taxiway arrangement according to claim 74 or 75 wherein the use of one of said plurality of paths does not affect the use of another of said plurality of paths.

77. An aircraft taxiway arrangement according to any of claims 74 to 76 further comprising a subterranean path for an aircraft tug.

78. An aircraft taxiway arrangement according to claim 73 or 77 wherein the subterranean path is between 1 m-4 m in height, preferably between 2 m-3 m in height.

79. An aircraft taxiway arrangement according to claim 73, 77 or 78 wherein the subterranean path is between 2 m-12 m in width.

80. A method of sorting of aircraft prior to take-off, the method comprising:
providing an area adjoining a runway comprising a plurality spaces for aircraft to queue;
arranging a plurality of aircraft in said plurality of bays;
instructing the aircraft to take off in order.

81. A method according to claim 80 wherein the arranging of the plurality of aircraft is by at least one of: aircraft size, runway length required, and wake turbulence produced.

82. A method according to claim 81 wherein the arranging of the plurality of aircraft is in the order of the wake turbulence they produce; and said instructing comprises instructing the aircraft to take off in order from the lowest wake turbulence-producing to the most.

83. A method according to any of claims 80 to 82 wherein the space provided for the aircraft requiring least runway length is provided at a position further along the runway compared to the space provided for the aircraft requiring most runway length.

84. A method according to any of claims 80 to 83 wherein said aircraft are towed to and/or from said bays.

85. A method according to claim 84 wherein said towing is performed using the system of any of claims 1 to 33.

86. A system for sorting aircraft prior to take-off, the system comprising:
an area adjoining a runway comprising a plurality spaces for aircraft to queue;
a plurality of aircraft arranged in said plurality of bays;
whereby the aircraft take off in order.

87. A system according to claim 86 wherein the arranging of the plurality of aircraft is by at least one of: aircraft size, runway length required, and wake turbulence produced.

88. A system according to claim 87 wherein the arranging of the plurality of aircraft is in the order of the wake turbulence they produce; and said instructing comprises instructing the aircraft to take off in order from the lowest wake turbulence-producing to the most.

89. A system according to any of claims 86 to 88 wherein neighbouring spaces for aircraft to wait have different widths according to the size of the aircraft.

90. A method of taxiing aircraft, comprising the steps of:
an aircraft tug towing a first aircraft to a runway;
the aircraft tug meeting a second aircraft having landed;
the aircraft tug towing said second aircraft away from a runway.

91. A method according to claim 90 wherein the aircraft tug tows the first aircraft to a first end of a runway, and meets the second runway at an opposing end of said runway.

92. A method according to claim 90 or 91 comprising the step of the aircraft tug travelling on an aircraft tug pathway between towing said first aircraft to a runway and meeting said second aircraft.

93. A method according to claim 92 wherein at least a portion of said aircraft tug pathway is subterranean.

94. A method according to any of claims 90 to 93 wherein the aircraft tug is inductively powered.

95. A system substantially as described herein in relation to the figures.

96. An aircraft tug substantially as described herein in relation to the figures.

97. A method substantially as described herein in relation to the figures.
